(19) United States
(12) Patent Application Publication
(10) Pub. No.: US 2026/0095989 A1
(43) Pub. Date: Apr. 2, 2026

(54) CIRCUITS FOR DRIVING LED MATRIX USING EQUALIZER SUBCIRCUIT AND SHARED AMPLIFIER FOR LED CLUSTERS IN THE CONTROL LOOP

(71) Applicant: Infineon Technologies AG, Neubiberg (DE)

(72) Inventors: Mattia Montoncelli, Abano Terme (IT); Rosario Chiodo, Selvazzano Dentro (PD) (IT); Adolfo De Cicco, Castel d'Azzano (VR) (IT); Alberto Bevilacqua, Padua (IT); Paolo Lorenzi, Padua (IT)

(21) Appl. No.: 18/899,945

(22) Filed: Sep. 27, 2024

(51) Int. Cl. H05B 45/44; F21S 41/153; F21Y 105/16; F21Y 115/10; H05B 45/325; H05B 47/155; H05B 47/165

(52) U.S. Cl. CPC H05B 45/44; H05B 45/325; H05B 47/155; H05B 47/165; F21Y 2105/16; F21Y 2115/10

(57) ABSTRACT

In some examples, this disclosure describes a method of controlling an N-by-M cluster of micro-LEDs, wherein N and M are positive integers. The method may comprise receiving, by an amplifier circuit, a reference voltage, and outputting, by the amplifier circuit, a regulated voltage to an equalizer subcircuit. The method may also comprise outputting, by the equalizer subcircuit, the regulated voltage to each of N×M power stages, and driving, by the N×M power stages, N×M mirco-LEDs based on the regulated voltage.

### TECHNICAL FIELD

This disclosure relates to circuits for driving and controlling pixelated light sources, such as for a vehicle headlamp comprising a matrix of light emitting diodes (LEDs) or other pixelated light sources.

### BACKGROUND

Driver circuits are often used to control a voltage, current, or power at a load. For instance, a light emitting diode (LED) driver may control the power supplied to one or many light emitting diodes. LED drivers may comprise voltage regulators, linear regulators, or DC to DC power converters, such as buck-boost, buck, boost, or another DC to DC power converter. DC to DC power converters may be especially useful for a LED drivers to regulate current through LED strings.

Some LED circuits include a large number of individually controllable LEDs arranged in a two-dimensional matrix. The individually controllable “micro” LEDs can be driven so as to provide different lighting (e.g., high beam or low beam lighting) for different driving conditions, or to provide advanced lighting effects.

Advanced vehicle headlamp systems, for example, are one example application of such matrix LED circuits, whereby lighting effects associated with vehicle operation can be used to improve the driving experience and to promote vehicle safety.

### SUMMARY

In general, this disclosure is directed to circuits used for controlling and driving a pixelated light source, such as those used for advanced vehicle headlamp systems, e.g., a matrix of so-called micro-light emitting diodes (micro-LEDs). The circuits of this disclosure may be configured to control clusters of the micro-LEDs using a shared operational transconductance amplifier (OTA) in a voltage regulation loop. To facilitate the sharing of the OTA for a micro-LED cluster, the circuits of this disclosure may utilize an equalizer subcircuit.

In some examples, this disclosure describes a lighting circuit configured to control an N-by-M cluster of micro-light emitting diodes (micro-LEDs), wherein N and M are positive integers. The lighting circuit may comprise an amplifier circuit configured to receive a reference voltage and output a regulated voltage, and an equalizer subcircuit. The lighting circuit may also comprise N×M power stages configured to drive N×M mirco-LEDs, wherein equalizer subcircuit is configured to output the regulated voltage to each of the N×M power stages.

In some examples, this disclosure describes a method that comprises controlling an N-by-M cluster of micro-LEDs, wherein N and M are positive integers, the method comprising: receiving, by an amplifier circuit, a reference voltage; outputting, by the amplifier circuit, a regulated voltage to an equalizer subcircuit; outputting, by the equalizer subcircuit, the regulated voltage to each of N×M power stages; and driving, by the N×M power stages, N×M mirco-LEDs based on the regulated voltage.

In some examples, this disclosure describes a lighting system comprising: a matrix of micro-light emitting diodes (micro-LEDs), wherein the matrix includes greater than 2000 micro-LEDs; and a plurality of lighting circuits each configured to control a unique N-by-M cluster of the micro-LEDs, wherein N and M are positive integers. Each of the plurality of lighting circuits may comprise an amplifier circuit configured to receive a reference voltage and output a regulated voltage; an equalizer subcircuit; and N×M power stages configured to drive N×M mirco-LEDs, wherein equalizer subcircuit is configured to output the regulated voltage to each of the N×M power stages. The system may comprise a vehicle headlamp module or another type of lighting module that utilizes a pixelated light source.

Details of these and other examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating system that includes a vehicle headlamp and a processor consistent with this disclosure.

FIG. 2 is a conceptual diagram showing a micro-LED driver matrix and a conceptual close-up view of one driver circuit connected to on micro-LED.

FIGS. 3A and 3B are circuit diagrams showing some example LED and driver arrangements.

FIGS. 4A and 4B are block diagrams showing example LED drivers that may provide output current (Iout) to an individual LED.

FIG. 5 is block diagram showing a circuit consistent with this disclosure.

FIG. 6 is another block diagram showing a circuit consistent with this disclosure.

FIG. 7 is a block diagram showing a system consistent with this disclosure.

FIG. 8 includes a timing diagram and a circuit diagram to show the use of PWM quanta for controlling LED states using a circuit consistent with this disclosure.

FIG. 9 is a circuit diagram showing layout of circuit components.

FIG. 10 is a flow diagram showing a method consistent with this disclosure.

### DETAILED DESCRIPTION

This disclosure is directed to circuits used for controlling and driving a pixelated light source, such as those used for advanced vehicle headlamp systems, e.g., a matrix of so-called micro-light emitting diodes (micro-LEDs). High density micro-LED drivers with dense micro-LED pitch (e.g., less than 100 micrometers or less than 50 micrometers) face severe challenges including a challenge for achieving accuracy of regulated currents for each of the micro-LED drivers.

The circuits of this disclosure may be configured to control clusters of the micro-LEDs using a shared operational transconductance amplifier (OTA) in a voltage regulation loop. To facilitate the sharing of the OTA for a micro-LED cluster, the circuits of this disclosure may utilize an equalizer subcircuit that is controlled by pulse modulation (PM) signals, such as pulse width modulation (PWM) signals. Each power stage may be connected to the shared OTA only at times when the power stage is controlling a micro-LED to be ON.

The circuit area needed to implement the equalizer subcircuit may be less than that would otherwise be needed to implement separate OTAs for each micro-LED driver. The additional circuit area can be utilized to facilitate a lager (more accurate) OTA for the cluster than could be achieved if separate OTA were implemented for each micro-LED in that cluster.

The circuits may be used to control and drive the lighting elements of a pixelated light source, such as a large number (e.g., greater than 2000) of micro-light emitting diodes (micro-LEDs). The techniques and circuits may improve the so-called “kilis” (i.e., gain factor) accuracy that can be achieved for high-density driver circuits associated with high-density pixelated light sources. Micro-LEDs may generally refer to LEDs with lateral pitch smaller than 100 micrometers, in some case smaller than 50 micrometers. As the size of micro-LEDs and corresponding driver circuits become smaller and smaller, challenges arise for circuit layout and circuit performance. One particular challenge is the quality and performance of OTAs, which affect the accuracy of the regulation loop for the micro-LED control. With high density systems, circuit area limitations can impede the ability to implement a high enough quality OTA for each micro-LED driver circuit that may be needed to achieve an acceptable accuracy of the gain factor (also referred to herein as the “kilis”).

Again, the circuits of this disclosure share an OTA in a voltage regulation loop used by several micro-LED drivers within a cluster of micro-LEDs. To facilitate such sharing of the OTA for a micro-LED cluster, the circuits of this disclosure may utilize an equalizer subcircuit that is controlled by PM signals, e.g., the same PM signals used by power stages of individual driver circuits for the micro-LEDs. In this way, each power stage may be connected to the shared OTA only at times when the power stage is controlling a micro-LED to be in an ON state. The OTA is operationally “ON” whenever at least one of the micro-LEDs of that cluster is ON, and the OTA is operationally “OFF” only when all of the micro-LEDs of that cluster are OFF.

The circuit area needed to implement the equalizer subcircuit may be less than that would otherwise be needed to implement separate OTAs for each micro-LED driver. The additional circuit area can be utilized to facilitate a larger and more accurate OTA (and associated logic or kilis elements for the OTA) for the cluster than could be achieved if separate OTAs and logic were implemented for each micro-LED in that cluster. The circuits may be especially desirable when the dimensions (or pitch) of the micro-LEDs are less than 100 micrometers, and even more specifically, less than 50 micrometers.

FIG. 1 is a block diagram illustrating system that includes a lighting circuit 10 and a processor 12 consistent with this disclosure. Processor 12 may provide control signals to lighting circuit 10. Based on the control signals, LED driver circuits 102 may provide individual control over LEDs 106. The control signals may comprise PM signals, such as PWM signals, pulse density modulation signals, or other types of modulation signals. LED driver circuits 102 may comprise transistors that are controlled operate as DC/DC converters in order to deliver regulated currents to LEDs 106.

According to this disclosure, lighting circuit 10 may be configured to control individual N-by-M clusters of micro-LEDs in a way that can improve the accuracy of so-called kilis (gain factor) in a regulation loop for the cluster. By sharing an OTA for the cluster and using an equalizer subcircuit to facilitate the sharing, improvements can be achieved that are especially desirable as the surface area dimensions of the micro-LEDs and corresponding micro-LED drivers become very small, such as having a pitch less than 100 micrometers or less than 50 micrometers.

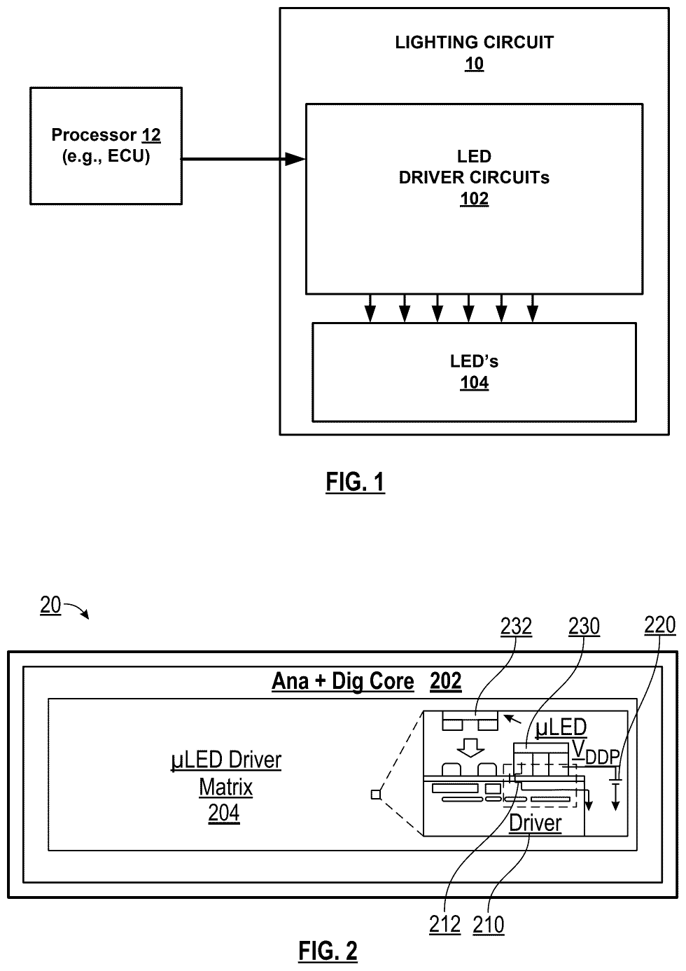

FIG. 2 is a conceptual diagram showing a micro-LED driver matrix 204 within an analog+digital core 202. FIG. 2 also includes a conceptual close-up view of one driver circuit 210 connected to on micro-LED 230. Micro-LEDs may be individually attached to micro-LED drivers, e.g., as depicted with micro-LED 232 and the arrow showing attachment of micro-LED 232 to a driver circuit that is directly adjacent driver circuit 210. Driver circuit 210 (as well as the other micro-LED driver circuits) includes controllable transistor 212. PM signals control the ON-OFF state of transistor 212 to deliver a controllable amount of current through micro-LED 230. A power source 220 may provide the power supply for driving current through micro-LED 230 by controlling transistor 212. The circuits of this disclosure may be implemented within an analog+digital core 202, such as that shown in FIG. 2.

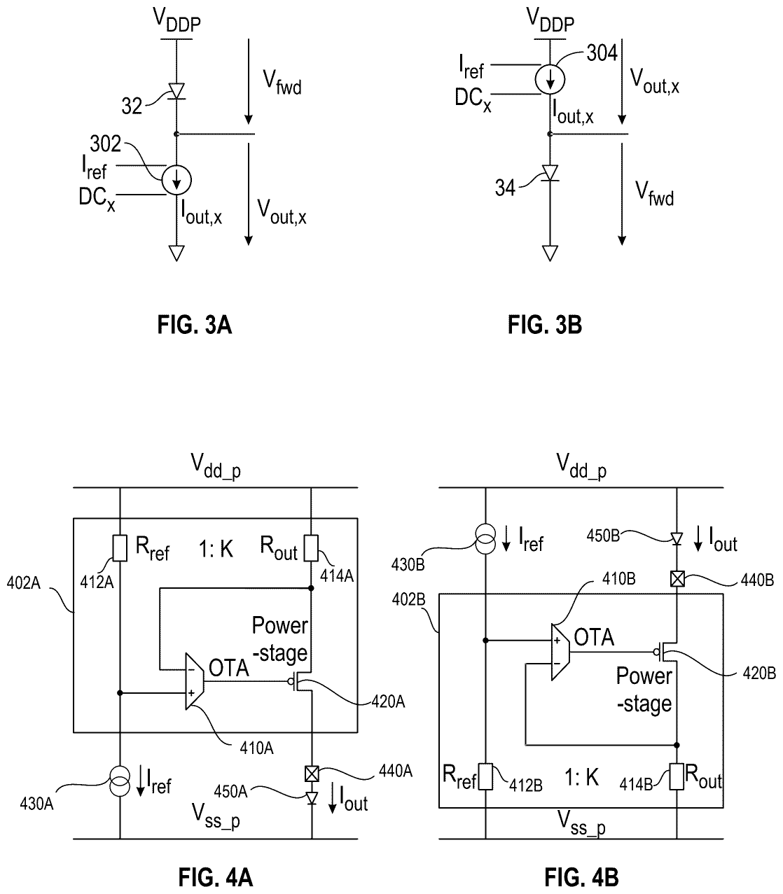

One basic function of a high-density pixel matrix micro-LED driver is to sink or source a regulated current from the cathode/anode of the micro-LED. FIGS. 3A and 3B illustrate two different example layouts. FIG. 3A shows a high-side configuration of micro-LED 32, where a current source 302 is positioned between micro-LED 32 and a ground to delivers current through micro-LED. FIG. 3B shows a low-side configuration of micro-LED 32, where a current source 304 is positioned between a supply node (V_{DDP}) and micro-LED 34.

Every individual micro-LED in a matrix of micro-LEDs may physically utilize a dedicated analog current signal (Iref) to generate a regulated output current (IOUTx), which may be determined by the formula:

$$IOUTx = k * Iref * DCx$$

where k is a constant “kilis” (gain factor) and IREF is a reference current. The IREF value may be generally equal across all the micro-LED drivers, and the IREF value may be varied or adjusted within a defined range. This feature allows adjustments to the matrix luminous flux acting as an analog dimming. DCx may comprise a dedicated digital control signal for each micro-LED driver. This DCx signal may contain duty-cycle information provided by an embedded digital dimming PWM engine. The DCx signal may be used to modulate individual pixel brightness defined in an intensity value in a video frame, e.g., by switching a transistor 212 between ON and OFF states. FIGS. 3A and 3B are two different example layouts of for a regulation loop for regulating IREF, which may be used to define Vref for a cluster of LEDs as described here. Again, two different examples of current source/sink regulation loop designs are show in FIGS. 3A and 3B.

FIGS. 4A and 4B shows one example of a lighting circuit 40 for an individual micro-LED 44 consistent with FIG. 3A or 3B. In the example shown in FIG. 4A, a circuit 402A is configured to control power to LED 450A connected to output pin 440A. Circuit 402A receives a reference current (IREF) from current source 430A, and resistor 412A creates a reference voltage based on the reference current. OTA 410A receives the reference current and outputs a regulated voltage to power stage 420A (e.g., a power transistor). The source of power stage 420A is fed back to OTA for the regulation loop, and output resistor 414A is arranged to facilitate this regulation control loop. OTA 410A is essentially “ON” whenever the transistor in power stage 420A is turned on.

The example shown in FIG. 4A has LED 450A positioned on a low-side, e.g., connected to Vss_p, which may be ground. In contrast, the example shown in FIG. 4B has LED 450B positioned on a high-side, e.g., connected to the supply voltage (Vdd_p). In the example shown in FIG. 4B, a circuit 402B is configured to control power to LED 450B connected to output pin 440B. Circuit 402B receives an IREF current from current source 430B, and resistor 412B creates a reference voltage based on the reference current. OTA 410B receives the reference current and outputs a regulated voltage to power stage 420B (e.g., a power transistor). The source of power stage 420B is fed back to OTA for the regulation loop, and output resistor 414B is arranged to facilitate this regulation control loop. OTA 410B is essentially “ON” whenever the transistor in power stage 420A is turned on.

In the examples of FIGS. 4A and 4B, OTA 410A, 410B provides the regulated voltage for driving the gate of a source follower power stage 420A, 420B to regulate the voltage nodes of a resistor-based kilis structure. On this topology, the kilis (gain factor) is defined as reference resistor over power stage resistor ratio (i.e., kilis (k)=Rref/Rout). In high density pixel matrix, a desirable product feature is the driver kilis accuracy. The main contributor is the error in the kilis introduced by the OTA. In general, the lager the OTA, the better the accuracy) which may be due to temperature and process spread. Negligible errors to kilis are further introduced by IREF current and resistors or other elements that define kilis.

Design of micro-LED drivers using circuits like those shown in FIGS. 4A and 4B may be based on the usage of a single error amplifier and a dedicated IREF for every pixel driver. By using this approach, in large pitch matrix (e.g., ≥50 um), typical kilis accuracy value is a single-digit value, while in finer pitch matrix (e.g., <50 um) a worse double-digit value can be expected. The main reasons for errors in kilis accuracy may be related to area and technology scaling limitation.

In other words, the circuits shown in FIGS. 4A and 4B may be desirable and effective for LED control, but they require an OTA for every LED, which becomes difficult in terms of circuit area as the sizes of LEDs and associated LED drivers becomes smaller and smaller. In particular, it can be difficult to achieve acceptable accuracy for the Kilis when the OTAs become smaller. Kilis accuracy with less than 10% error is desirable, e.g., with a target of 7% error or better for Kilis accuracy. However, with circuits like that shown in FIG. 4A or 4B, at pitches at or less than 50 micrometer 14% error accuracy may be the best possible accuracy due to size and scaling limitations. There is not enough space due to technology scaling and size reductions.

To address challenges, this disclosure proposes a circuit solution that utilizes one OTA for a cluster of micro-LEDs, which can achieve kilis accuracy with less than 10% error or less than 7% error in the kilis accuracy. The cluster may comprise 4 LEDS, 6 LEDs, 8 LEDs, 10 LEDs, 16 LEDs, or generally any number of micro-LEDs. To facilitate the sharing of the OTA for a micro-LED cluster, the circuits of this disclosure may utilize an equalizer subcircuit that is controlled by PM signals, such as PWM signals. In some examples, the same PM signals used to control power transistors in power stages can be used by switches in the equalizer subcircuit. Any time a power stage is controlling a micro-LED on, a corresponding switch in the equalizer circuit may connect that power stage to the OTA. Some or all of the micro-LED driver circuits (e.g., the power stages) may be simultaneously connected to the OTA. The OTA remains “ON” as long as one of the power stages is controlling a micro-LED to be ON, and the OTA is operationally “OFF” only when all of the power stages for a cluster and controlling all of the micro-LEDs of that cluster to be “OFF.”

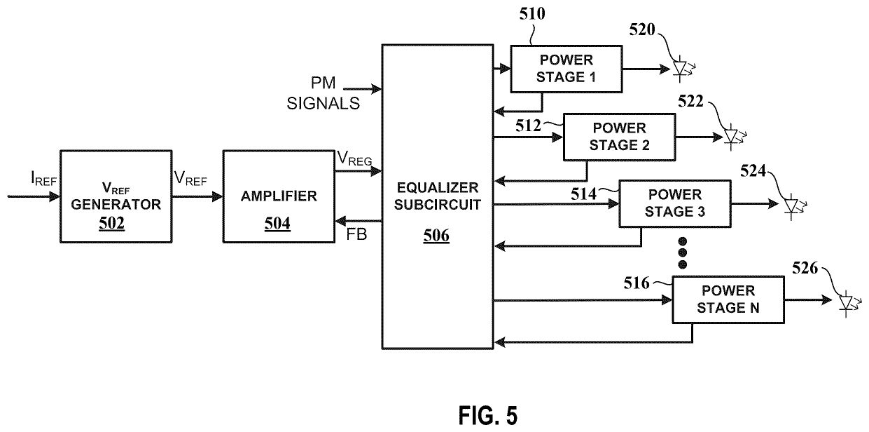

FIG. 5 a circuit consistent with this disclosure. In some examples, amplifier 504, equalizer subcircuit 506 and power stages 510, 512, 514 and 516 define a lighting circuit configured to control, an N-by-M cluster of micro-LEDs 520, 522, 524, 526. N and M are positive integers and N×M is 2 or greater, meaning that N×M is a plurality. Therefore, in the example shown in FIG. 5, showing four micro-LEDs 520, 522, 524, 526, M and N may each be 2, or M may be 4 and N may be 1, or M may be 1 and N may be 4. Other cluster sizes may also be used consistent with this disclosure.

In the circuit of FIG. 5, Vref generator 502 receives a reference current (I_{REF}) and generates a voltage reference (V_{REF}) based on the reference current. An amplifier circuit 504 is configured to receive a reference voltage and output a regulated voltage (V_{REG}). For example, amplifier circuit 504 may comprise an OTA or another suitable amplifier structure useful for a voltage regulation loop. N×M power stages (in this example four power stages) 510, 512, 514, 516 are configured to drive N×M mirco-LEDs 520, 522, 524, 526. Equalizer subcircuit is configured to output the regulated voltage to each of the N×M power stages, e.g., to the gate of a power transistor for each of the N×M power stages, which each may comprise a source follower power transistor. In other words, each of the N×M power stages 510, 512, 514, 516 may comprise a source follower power stage with a gate control voltage for the cluster being defined by amplifier 504 and connection to the gate control voltage for each of the N×M power stages 510, 512, 514, 516 being defined by equalizer subcircuit 506.

The N×M cluster of micro-LEDs 520, 522, 524, 526 may be a small portion of a matrix of the micro-LEDs, which may be associated with a vehicle headlamp or another lighting system. Hence, the circuit shown in FIG. 5 may be duplicated for a large number of clusters of N×M power stages in order to control an entire matrix of micro-LEDs. The entire matrix, for example, may comprise approximately 2000 micro-LEDs, approximately-4000 micro-LEDs, approximately 10000 micro-LEDs, approximately 10000 micro-LEDs, approximately 90,000 micro-LEDs, approximately 100,000 micro-LEDs, or any sized matrix. Again, vehicle headlamps are one use case, but the lighting circuit may be used for of other matrix lighting applications.

Each of the N×M power stages 510, 512, 514, 516 may be arranged on circuit areas that have dimensions (e.g., pitch between power stages) of less than 100 micrometers. In some cases, each of the N×M power stages 510, 512, 514, 516 may be arranged on circuit areas that have pitch less than 50 micrometers. With these very small dimensions, it can become difficult to implement an accurate amplifier for each power stage. To address this issue, the circuits of this disclosure implement one amplifier 504 for an entire cluster of LED power stages, and use an equalizer subcircuit 506, which may comprise a set of high-ohmic switches to provide access to the output of amplifier 504

In some examples, equalizer subcircuit 506 may comprise a plurality of switches that are arranged and controlled to output the regulated voltage to each of the N×M power stages 510, 512, 514, 516 to regulate a source and a gate of each of the N×M power stages 510, 512, 514, 516. The N×M power stages 510, 512, 514, 516 may comprise power transistors that are controlled via PM signals to deliver current to the N×M mirco-LEDs. Different PM signals for different ones of the power transistors of N×M power stages 510, 512, 514, 516 can be used to also control the plurality of switches of equalizer subcircuit 506. In some cases, different PM signals for different ones of the power transistors of N×M power stages 510, 512, 514, 516 can be used for digital dimming on a pixel-by-pixel basis.

Controlling switches of equalizer subcircuit 506 may be based on logic signals that define a number of PWM quanta. PWM signals may be defined by quanta of a large PWM duty cycle, wherein the PWM quanta define ON-OFF states for each of the N×M mirco-LEDs within a PWM duty cycle.

Equalizer subcircuit 506 may include yet additional switches to facilitate feedback in the voltage regulation loop for the N-M cluster of micro-LEDs 520, 522, 524, 526. Thus, output of each of the N×M power stages is also connected back to the equalizer circuit. Thus, the plurality of switches of equalizer subcircuit 506 may further includes feedback switches, wherein equalizer subcircuit 506 is configured to deliver a feedback signal (FB) to amplifier 504. In this case, the feedback signal is defined by controlling the feedback switches of equalizer subcircuit 506, e.g., based on a logic signal. In this way or possibly other ways, the output of each of the N×M power stages 510, 512, 514, 516 is connected to equalizer subcircuit 506 and equalizer circuit is configured to deliver a feedback signal (FB to amplifier 504 to form a voltage regulation loop for the N×M micro-LED cluster.

An equalizer sub-circuit can be introduced for every MxN LED cluster of a high-density pixel matrix with the aim to share a single OTA among the power stages of each MxM cluster, so as to improve LED lighting (e.g., accuracy, drop-out, power consumption, or other factors) of each micro-LED cluster being driver. Indeed, the use of a single OTA instead of MxN OTAs can lead to a circuit area saving, which can be used to improv the performances of the MxN shared regulation loops. The area of equalizer subcircuit 506 can be considered as negligible in some cases, as equalizer subcircuit 506 can be realized using several small-sized metal oxide semiconductor transistors. In some examples, the amount of area needed to implement equalizer subcircuit 506 may be considerably less than the amount of area needed to implement three additional amplifiers. Hence, by sharing one amplifier 504 and implementing equalizer subcircuit 506 to facilitate the sharing, circuit area savings can be achieved to allow a larger and more accurate amplifier 504 than could otherwise be achieved.

The same PWM signals used to control the ON-OFF states of power transistors of power stages 510, 512, 514, 516 can also be used to control the switches of equalizer subcircuit 506 such that the regulated output of amplifier 504 is only connected to those power stages that are controlling LEDs to be ON. This type of coordinated control can also achieve power efficiencies.

The current sink/source activation of micro-LEDs within a PWM period in pixelated lighting devices may be divided into smaller quanta withing PWM period. The PWM period may define a duty cycle, which can be split in 2\hat{ }10=1024 PWM quanta which correspond to the minimum duty-cycle resolution. All current sinks/sources are active for a certain number of PWM quanta according to the selected duty cycle. The same PWM quanta control of the power stages may also be used to control switches of equalizer subcircuit 506 for both the output control and feedback control.

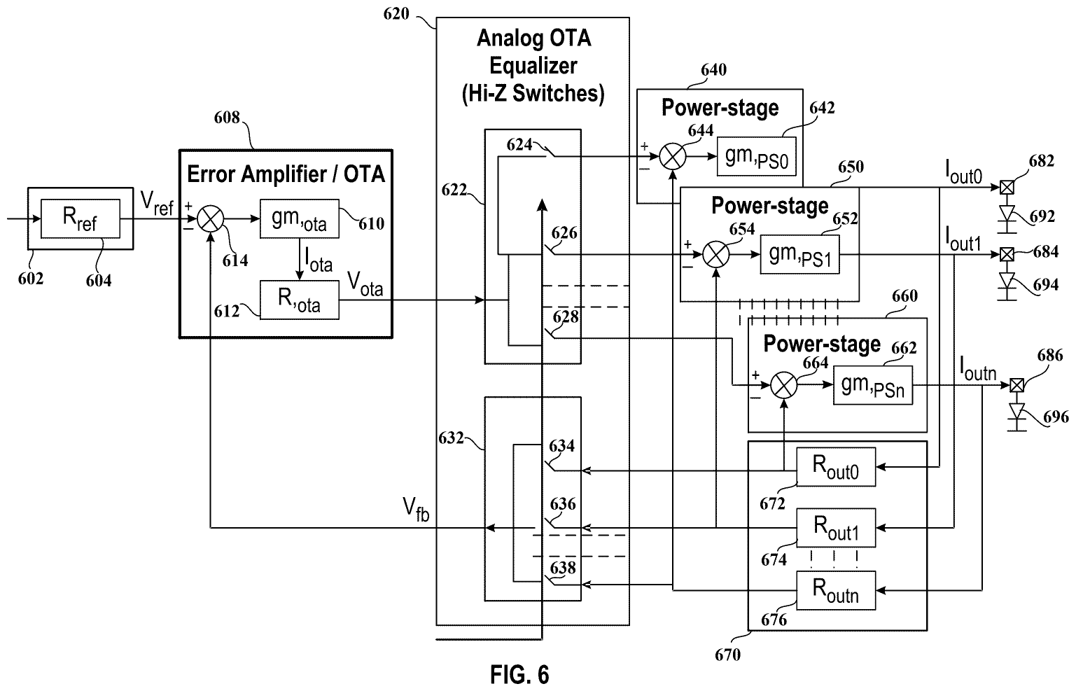

FIG. 6 is another block diagram showing a circuit consistent with this disclosure. FIG. 6 is consistent with FIG. 5, but FIG. 6 shows a more detailed example than FIG. 5. In some examples, error amplifier 608, equalizer subcircuit 620 and power stages 640, 650, 660 and 660 define a lighting circuit configured to control an N-by-M cluster of micro-LEDs represented by micro-LEDs 692, 694, 696. Output pins 682, 684, 686 of the lighting circuit may facilitate connection of the lighting circuit to micro-LEDs 692, 694, 696. Again, N and M are positive integers and N×M is 2 or greater, meaning that N×M is a plurality. Put another way, at least one of N or M may be a positive integer greater than 1. In FIG. 6 micro-LEDs 692, 694, 696 generally represent any plurality of LEDs. N×M may be less than 100 or less than 50 for most practical applications, although the circuits could also be used for even larger clusters.

In the circuit of FIG. 6, Vref generator 602 may receive a reference current and generates a voltage reference (V_{REF}) based on the reference current. Vref generator 602 may comprise a reference resistor 604 or another defined element to define Vref based on an Iref current. An error amplifier circuit 608 (e.g., an OTA) is configured to receive the reference voltage (V_{REF}) and output a regulated voltage (V_{OTA}). To do so, error amplifier 608 may introduce a gain that may also be defined or affected by transconductance (gm) 610 of error amplifier 608, and error amplifier 608 may output a current I_{OTA} through a resistor 612 to create regulated the regulated output voltage V_{OTA}. The feedback (Vfb) for the entire cluster is received by error amplifier 608 at node 614 to form a closed loop of voltage regulation for V_{OTA}.

N×M power stages (represented generally by power stages 640, 650, 660) are configured to drive N×M mirco-LEDs (represented by micro-LEDs 692, 694, 696). Equalizer subcircuit 620 may comprise an analog OTA equalizer that includes high-ohmic switches (High-Z switches). In particular, in this example, equalizer subcircuit 620 includes a first set of output switches 622 and second set of feedback switches 632. Output switches 622 and feedback switches 632 can be controlled by the same PWM signals (e.g., the same PWM quanta) as used to control transistors in power stages 640, 650, 660. In this way, any time a power stage is driving a micro-LED to an “ON state” output switches 622 are controlled in a synchronous manner by the same PWM signals to ensure that V_{OTA} is available to that power stage. Similarly, any time a power stage is driving a micro-LED to an “ON state” feedback switches 632 are controlled in a synchronous manner by the same PWM signals to ensure that VFB is affected by that power stages feedback.

Equalizer subcircuit 620 may be configured to output the regulated voltage (V_{OTA}) to each of the N×M power stages, e.g., to the gate of each of the N×M power stages 640, 650, 660. Power stages 640, 650, 660 may comprise a source follower power transistor. The output of each of stages 640, 650, 660 is fed back through a set 670 of output resistors 672, 674, 676 to the input of each of power stages 640, 650, 660 to form separate open regulation loop for the current provided to each of micro-LEDs 692, 694, 696. Each of the N×M power stages 640, 650, 660 may comprise a source follower power stage with a gate control voltage for the cluster being defined by error amplifier 608, and connection to the gate control voltage for each of the N×M power stages 640, 650, 660 may be defined by equalizer subcircuit 620. Each of power stages 640, 650, 660 may define a gain that may also be defined or affected by the transconductance (gm) 642, 652, 662 of each of power stages 640, 650, 660, which may be different or similar for some or all of LEDs 692, 694, 696.

The individual feedback through output resistors 672, 674, 676 to the input of each of power stages 640, 650, 660 at nodes 644, 654, 664 defines individual regulation loops (i.e. open loops). In addition, the combined feedback through output resistors 672, 674, 676 is also fed back through feedback switches 632 to define a second regulation loop (i.e., a closed loop) for error amplifier 608 to regulate V_{OTA} for the entire cluster of micro-LEDs.

In the example shown in FIG. 6, output switches 622 include an individual switch 624, 626, 628 corresponding to each of power stages 640, 650, 660. Similarly, feedback switches 632 include an individual switch 634, 636, 638 corresponding to each of power stages 640, 650, 660. However, other more complex switching circuits could also be used by equalizer circuit 620 consistent with this disclosure.

The individual switches 624, 626, 628, 634, 636, 638 within equalizer subcircuit 620 may comprise high-ohmic switches (e.g., in the range of hundreds of Kohm). One aim of switches 624, 626, 628, 634, 636, 638 is to connect/disconnect the output and the feedback lines from the shared error amplifier 608 to the “N×M” power stages at the beginning of each PWM quanta. The equalizer switches can be driven by digital PWM signals, when PWM signal is set to High level (which means pixel on), the corresponding output switches 622 feedback switches 632 are immediately activated and keep the on state for all the correspondingly active PWM quanta.

In some examples, the same logic control circuit(s) that define the on-off signals for micro-LED drivers (e.g., in power stages 640, 650, 660) can be used as the logic to control the switches within equalizer subcircuit 620. In other words, the same control logic can be used, but the control signals can be delivered simultaneously micro-LED driver switches of power stages 640, 650, 660 and to output switches 622 and feedback switches 632 of equalizer subcircuit 506. Error amplifier 608 is only OFF in the situation where all LEDs 692, 694, 696 are off for a given quanta. One or all output stages can be connected to the OTA at any time to get the proper gate voltage. Sharing gate and feedback creates the same output current (for a given quanta), but PM signals can still modulate duty cycles on a pixel-by-pixel basis.

In general, equalizer subcircuit comprises 620 comprises a plurality of switches (e.g., output switches 622) that are arranged and controlled to output the regulated voltage to each of the N×M power stages 640, 650, 660 to regulate a source and a gate of power transistors within of the N×M power stages 640, 650, 660. The N×M power stages 640, 650, 660 may comprise power transistors that are controlled via pulse modulation signals to deliver current to the N×M mirco-LEDs 692, 694, 696, and in some cases different pulse modulation signals for different ones of the power transistors are also used for controlling the plurality of switches (e.g., output switches 622) of the equalizer subcircuit. Controlling output switches 622 of the equalizer subcircuit 620 may be based on logic signals that define a number of PWM quanta, wherein the PWM quanta define ON-OFF states for each of the N×M mirco-LEDs within a PWM duty cycle. Moreover, output of each of the N×M power stages 640, 650, 660 is connected back to the equalizer circuit, wherein the plurality of switches of the equalizer circuit further includes feedback switches 632, wherein the equalizer circuit is configured to deliver a feedback signal (Vi) to error amplifier 608, wherein the feedback signal also is defined by controlling the feedback switches 632 based on the logic signal (e.g., the same logic signals that control power transistors of power stages 640, 650, 660 and the same logic signals that control output switches 622.

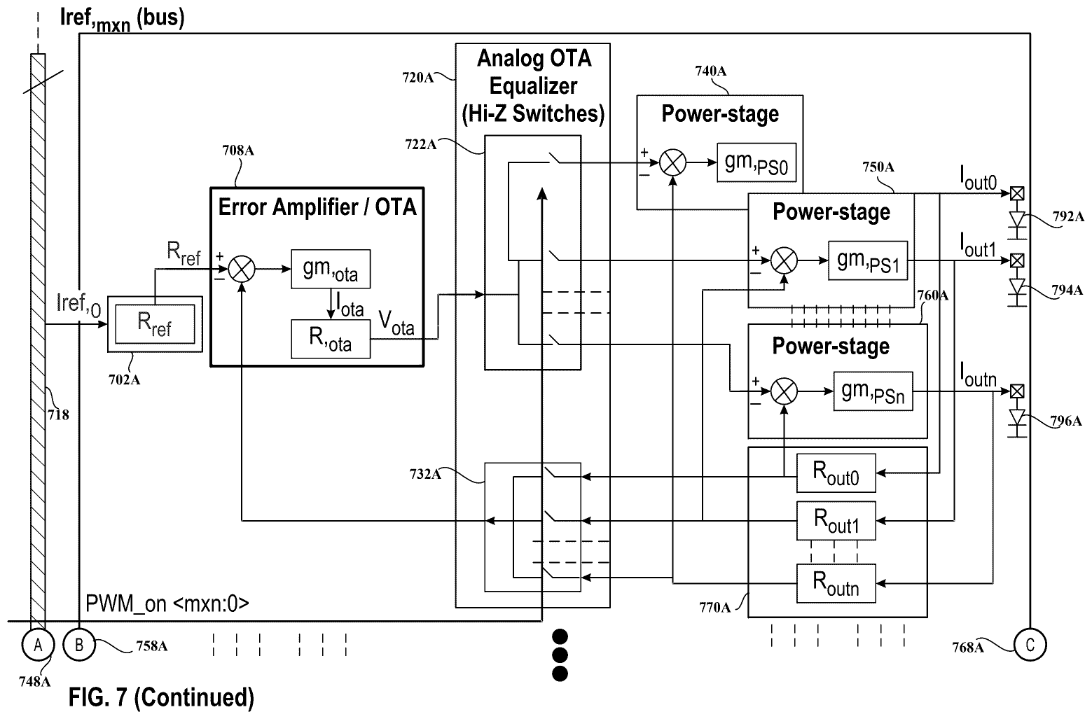

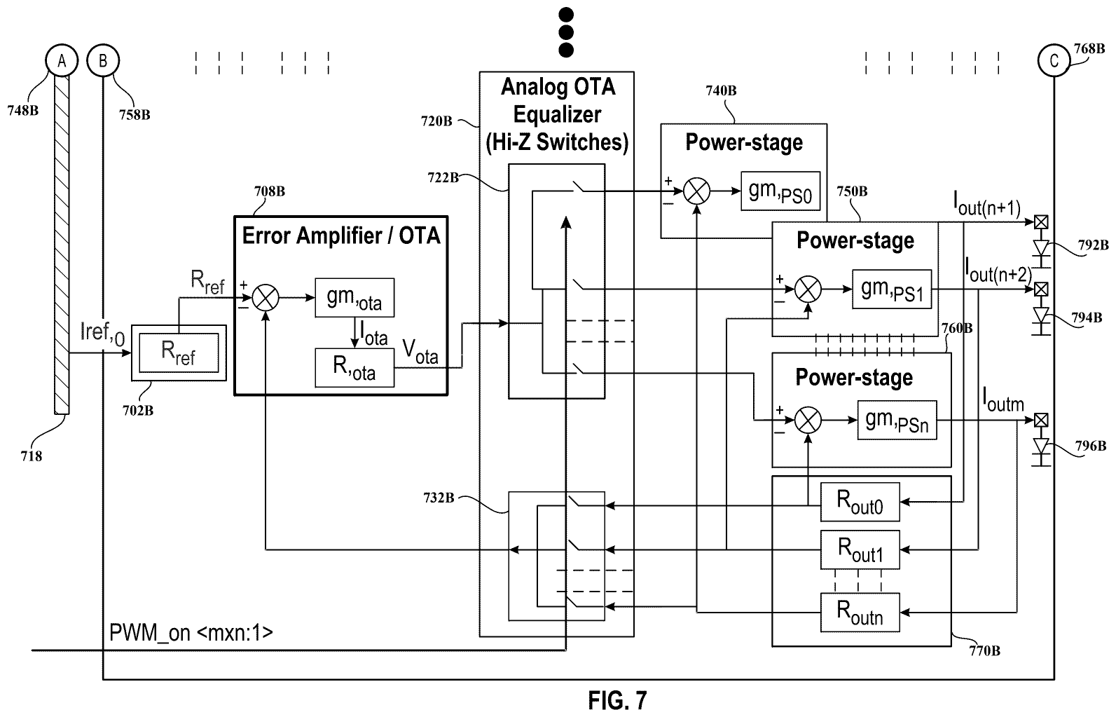

FIG. 7 is a block diagram showing a system consistent with this disclosure. The system shown in FIG. 7 is essentially a combination of two or more of the circuits shown in FIG. 6. Although the circuit shown in FIG. 6 is duplicated two times in the system diagram of FIG. 7, any number of circuits similar to that of FIG. 6 could be combined as shown in FIG. 7 in order to control any number of LEDs in a very large matrix. In other words, circuits like that shown in FIG. 6 can be combined as shown in FIG. 7 to control any number of subsets of micro-LEDs. Each subset of micro-LEDs may be controlled using a shared OTA via a circuit like that of FIG. 6. Each circuit may be connected to a common input bus 718 as shown in FIG. 7. FIG. 7 spans two pages in the figures and nodes A, B, and C are connected to each other, i.e., 748A is connected to 748B at NODE A. 758A is connected to 758B at NODE B, and 768A is connected to 758B at NODE C to define a box around the system.

The details of FIG. 7 are the same as that of FIG. 6, although the circuit is duplicated twice. Again, any number of circuits like that of FIG. 6 could be combined as shown in FIG. 7. Vref generators 702A, 702B operate like Vref generator 602 described above. Error amplifiers 708A, 708B operate like error amplifier 608. Equalizer subcircuits 720A, 720B operate like equalizer subcircuit 620. Output switches 722A, 722B operate like output switches 622, and feedback switches 732A, 732B operate like feedback switches 632. Power stages 740A, 750A, 760A and power stages 740B, 750B, 760B operate like power stages 640, 650, 660. The set of output resistors 770A and the set of output resistors 770B operate like the set of output resistors 670.

A system like that shown in FIG. 7 may include any number of circuits similar to that of FIG. 6 in order to control any number of micro-LEDs 792A, 794A, 796A, 792B, 794B, 796B. In other words, the system shown in FIG. 7 may generally represent a system for controlling an entire matrix of micro-LEDs. A large number of individual circuits like that of FIG. 6 can be used to together (e.g., as shown in FIG. 7) to create a system for controlling an entire matrix of micro-LEDs, which may comprise approximately 2000 micro-LEDs, approximately 4000, approximately 10000 micro-LEDs, approximately 16,000 micro-LEDs, approximately 100,000 micro-LEDs, or any number of micro-LEDs within a large matrix.

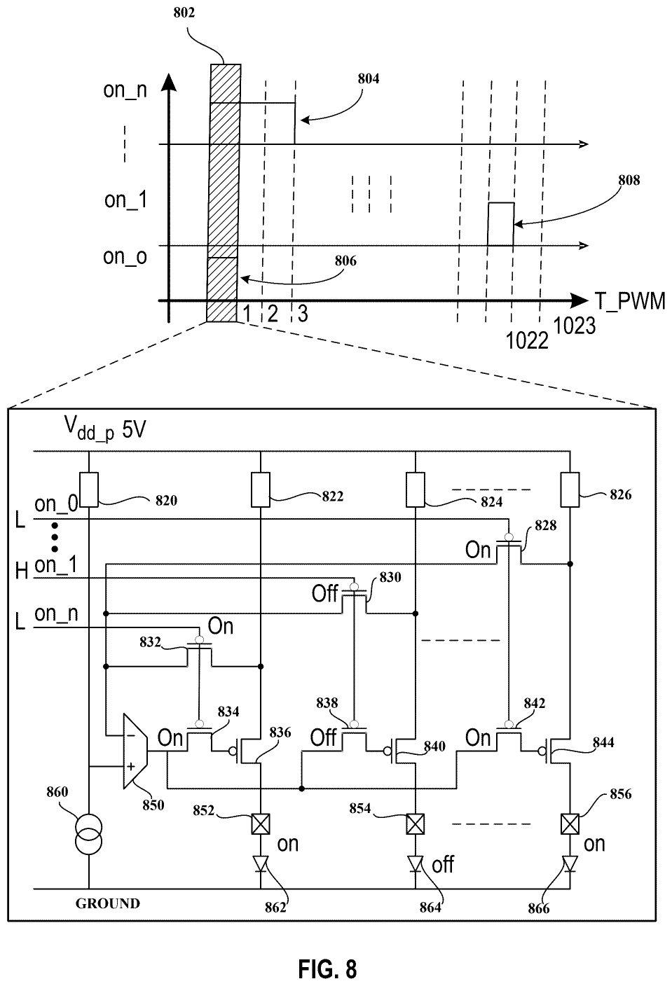

FIG. 8 shows an example of PWM pattern with focus on the first PWM quanta 802. In this example, in the first quanta, LED_0 is ON for the first quanta (as shown at 806) LED_1 is OFF (i.e., no “ON” signal for LED 1), and LED_n is ON at 804 for the first three quanta. LED_1 is also shown as being “ON” in a 1021^{st} quanta at 808. In this example, there are 1024 quanta (i.e., from 0 to 1023). Duty cycles may define other numbers of quanta, and FIG. 7 merely shows one example.

FIG. 8 also illustrates a corresponding circuit and control the circuit consistent with the first PWM quanta 802 shown in FIG. 8. The circuit shown in FIG. 8 shows micro-LEDs 862, 864, 866 connected to output pins 852, 854, 856, and regulated 1 mA currents (or other values) can be selectively delivered to individual ones of micro-LEDs 862, 864, 866.

Two supply nodes are labeled in FIG. 8 as Vdd_p (which may correspond to 5 Volts or another supply volt value) and GROUND (which may correspond to actual ground or another reference voltage). A current source 860 delivers a reference current to the circuit and resistor 820 defines a reference voltage for OTA 850. Micro-LEDs 862, 864, 866 are controlled ON or OFF by controlling power transistors 836, 840, 844, e.g., according to the PWM quanta control signals. Power transistors 836, 840, 844 can be viewed as being the output stages for controlling micro-LEDs 862, 864, 866

Output resistors 822, 824, 826 may define gain factors that are also dependent on reference resistor 820. The gains can be the same or different, depending on whether similar currents are needed for driving each of micro-LEDs 862, 864, 866. Switches 828, 842, 830, 838, 832, and 834 may represent switches within an equalizer subcircuit that are controlled by the same PWM quanta used for controlling power transistors 836, 840, 844 to define the ON-OFF states of micro-LEDs 862, 864, 866. Thus, switches 832, 834 (of an equalizer subcircuit) are controlled ON when power transistor 836 is ON, such as during the first quanta 802. Similarly, switches 830, 838 (of an equalizer subcircuit) are controlled OFF when power transistor 838 is OFF, such as during the first quanta 802. And switches 828, 842 are controlled ON when power transistor 844 is ON, such as during the first quanta 802. In this way, OTA 850 can be shared for defining a regulated output voltage for the entire cluster of micro-LEDs, while individual micro-LED control can be defined by the PWM quanta control. OTA 850 is essentially switched in to provide the regulated V_{OTA} only when the corresponding micro-LED is being driven ON and switched out (and unavailable to a micro-LED driver) when the corresponding micro-LED is turned OFF in any given quanta of the duty cycle.

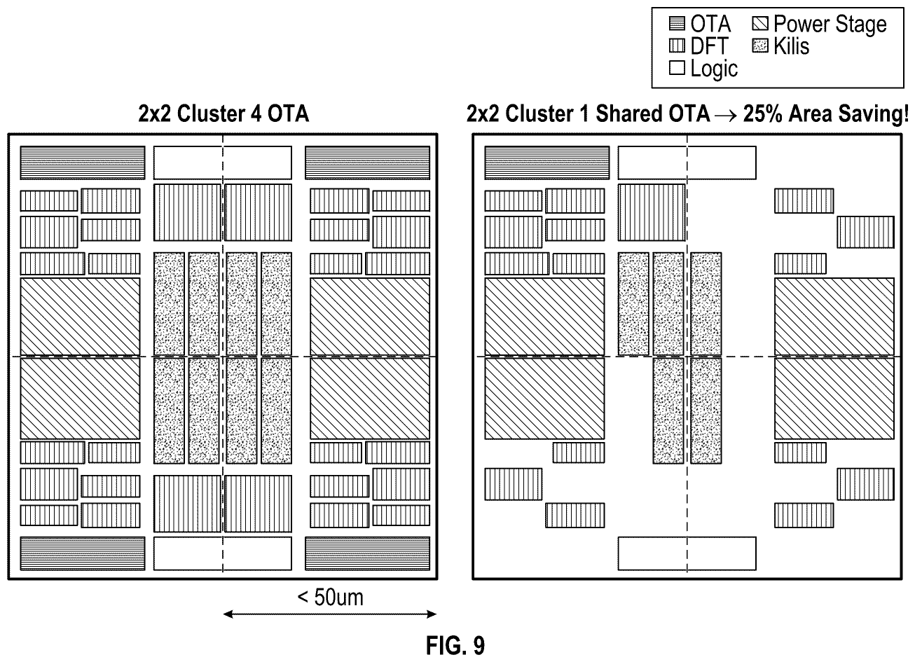

FIG. 9 is a conceptual diagram showing circuit layout, with a “Key” that identifies the OTA, design for testing (DFT) circuit, power stages, kilis elements, and logic. In the 2×2 cluster shown on the left, the circuit layout includes a separate OTA for every micro-LED pixel and micro-LED driver. As shown, as track pitches become less than 50 micrometers, there is no additional space to create a larger and better OTA (along with associated kilis and logic elements). The 2×2 cluster on the right shows a 25% surface area savings in the elimination of three OTAs relative to the 2×2 cluster on the left. In the 2×2 cluster shown in the right, one OTA is used to service all four micro-LED drivers. This 25% savings is more than sufficient to allow for area for an equalizer subcircuit and to also enlarge the size of the single OTA in the 2×2 cluster on the right.

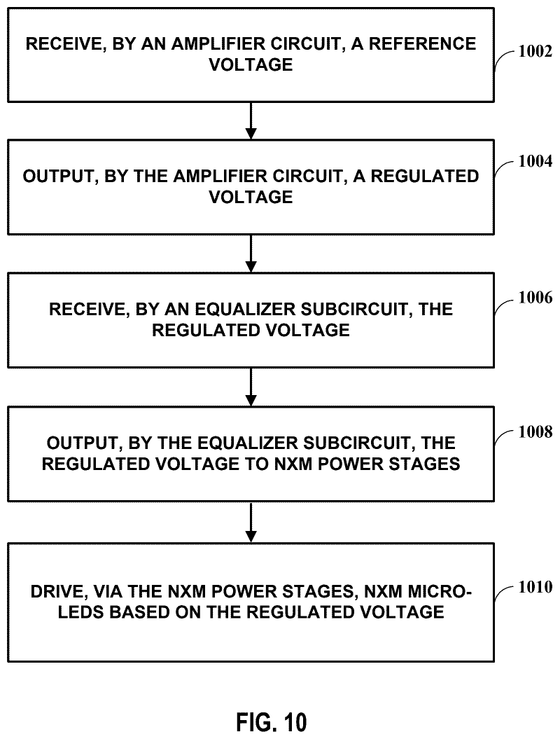

FIG. 10 is a flow diagram showing a method consistent with this disclosure. FIG. 10 will be described from the perspective of the circuit shown in FIG. 6, although other circuits could perform the same method. As shown in FIG. 10, an amplifier circuit (e.g., error amplifier 608) receives a reference voltage (Vref) (1002). The amplifier circuit (e.g., error amplifier 608) outputs a regulated voltage (V_{OTA}) (1004). Equalizer subcircuit 620 receives the regulated voltage (V_{OTA}) (1006), and outputs the regulated voltage (V_{OTA}) to N×M power stages 640, 650, 660 (1008). The N×M power stages 640, 650, 660 then drive N×M micro-LEDs 692, 694, 696 based on the regulated voltage (V_{OTA}) (1010). The regulated voltage (V_{OTA}) may define the regulated voltage for both the gate and source of a power transistor in each of N×M power stages 640, 650, 660, and PWM signals may control the ON-OFF states on a pixel-by-pixel basis.

The techniques described in this disclosure may be implemented in circuitry. In various examples, the techniques may be implemented, at least in part, in circuitry, hardware, software, firmware or any combination thereof. For example, various aspects of the described techniques may be implemented within one or more logical elements, processors, including one or more microcontrollers, microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such circuitry, hardware, software, and firmware may be implemented within the same device or integrated circuit or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

It may also be possible for one or more aspects of this disclosure to be performed in software, e.g., especially for logic or decisions that are preformed based on circuit output, in which case those aspects of the techniques described in this disclosure may also be embodied or encoded in a computer-readable medium, such as a computer-readable storage medium, containing instructions. Instructions embedded or encoded in a computer-readable storage medium may cause a processor, to perform the method, e.g., when the instructions are executed. The instructions, in this example, may be stored in a memory, which may comprise random access memory (RAM), read only memory (ROM), programmable read only memory (PROM), erasable programmable read only memory (EPROM), electronically erasable programmable read only memory (EEPROM), flash memory, or other computer readable media.

The following clauses may illustrate one or more aspects of the disclosure.

Clause 1: A lighting circuit configured to control an N-by-M cluster of micro-LEDs), wherein N and M are positive integers, the lighting circuit comprising: an amplifier circuit configured to receive a reference voltage and output a regulated voltage; an equalizer subcircuit; and N×M power stages configured to drive N×M mirco-LEDs, wherein equalizer subcircuit is configured to output the regulated voltage to each of the N×M power stages.

Clause 2: The lighting circuit of clause 1, wherein the lighting circuit is configured to control the N-by-M cluster within a matrix of the micro-LEDs associated with a vehicle headlamp.

Clause 3: The lighting circuit of clause 1 or 2, wherein each of the N×M power stages are arranged on circuit areas that have a pitch less than 100 micrometers.

Clause 4: The lighting circuit of any of clauses 1-3, wherein each of the N×M power stages comprises a source follower power stage.

Clause 5: The lighting circuit of any of clauses 1-4, wherein N=2 and M=2.

Clause 6: The lighting circuit of clause any of clauses 1-5, wherein the equalizer subcircuit comprises a plurality of switches that are arranged and controlled to output the regulated voltage to each of the N×M power stages to regulate a source and a gate of each of the N×M power stages.

Clause 7: The lighting circuit of clause 6, wherein the N×M power stages comprise power transistors that are controlled via pulse modulation signals to deliver current to the N×M mirco-LEDs, wherein different pulse modulation signals for different ones of the power transistors are defined by controlling the plurality of switches of the equalizer subcircuit.

Clause 8: The lighting circuit of clause 6 or 7, wherein controlling the plurality of switches of the equalizer subcircuit is based on logic signals that define a number of PWM quanta, wherein the PWM quanta define ON-OFF states for each of the N×M mirco-LEDs within a PWM duty cycle.

Clause 9: The lighting circuit of any of clauses 6-8, wherein output of each of the N×M power stages is connected to the equalizer subcircuit, wherein the plurality of switches of the equalizer subcircuit further includes feedback switches, wherein the equalizer subcircuit is configured to deliver a feedback signal to the amplifier, wherein the feedback signal is defined by controlling the feedback switches based on the logic signal.

Clause 10: The lighting circuit of any of clauses 1-9, wherein output of each of the N×M power stages is connected to the equalizer subcircuit, wherein the equalizer subcircuit is configured to deliver a feedback signal to the amplifier.

Clause 11: A method of controlling an N-by-M cluster of micro-LEDs, wherein N and M are positive integers, the method comprising: receiving, by an amplifier circuit, a reference voltage; outputting, by the amplifier circuit, a regulated voltage to an equalizer subcircuit; outputting, by the equalizer subcircuit, the regulated voltage to each of N×M power stages; and driving, by the N×M power stages, N×M mirco-LEDs based on the regulated voltage.

Clause 12: The method of clause 11, wherein each of the N+M power stages comprises a source follower power stage.

Clause 13: The method of clause 11 or 12, wherein N=2 and M=2.

Clause 14: The method of any of clauses 11-13, wherein the equalizer subcircuit comprises a plurality of switches, the method further comprising controlling the plurality of switches to output the regulated voltage to each of the N×M power stages.

Clause 15: The method of clause 14, wherein the N×M power stages comprise power transistors that are controlled via pulse modulation signals to deliver current to the N×M mirco-LEDs, the method further comprising controlling the plurality of switches of the equalizer subcircuit based on the pulse modulation signals.

Clause 16: The method of clause 14 or 15, wherein controlling the plurality of switches of the equalizer subcircuit is based on logic signals that define a number of pulse width modulation (PWM) quanta, wherein the PWM quanta define ON-OFF states for each of the N×M mirco-LEDs within a PWM duty cycle.

Clause 17: The method of any of clauses 14-16, further comprising: delivering output of each of the N+M power stages back to the equalizer subcircuit, wherein the plurality of switches of the equalizer subcircuit further includes feedback switches; and delivering a feedback signal from the equalizer subcircuit to the amplifier, wherein the feedback signal is defined by controlling the feedback switches based on the logic signal.

Clause 18: The method of any of clauses 11-17, wherein output of each of the N×M power stages is connected to the equalizer subcircuit, wherein the equalizer subcircuit is configured to deliver a feedback signal to the amplifier.

Clause 19: A lighting system comprising: a matrix of micro-LEDs, wherein the matrix includes greater than 2000 micro-LEDs; a plurality of lighting circuits each configured to control a unique N-by-M cluster of the micro-LEDs, wherein N and M are positive integers, wherein each of the plurality of lighting circuits comprises: an amplifier circuit configured to receive a reference voltage and output a regulated voltage; an equalizer subcircuit; and N×M power stages configured to drive N×M mirco-LEDs, wherein equalizer subcircuit is configured to output the regulated voltage to each of the N×M power stages.

Clause 20: The lighting system of clause 19, wherein the lighting system comprises a vehicle headlamp.

Clause 21: The lighting system of clause 19, wherein each of the plurality of lighting circuits comprises the lighting circuit of any of clauses 1-10.

Various aspects have been described in this disclosure. These and other aspects are within the scope of the following claims.

1. A lighting circuit configured to control an N-by-M cluster of micro-light emitting diodes (micro-LEDs), wherein N and M are positive integers, the lighting circuit comprising:
an amplifier circuit configured to receive a reference voltage and output a regulated voltage;
an equalizer subcircuit; and
N×M power stages configured to drive N×M mirco-LEDs, wherein equalizer subcircuit is configured to output the regulated voltage to each of the N×M power stages.

2. The lighting circuit of claim 1, wherein the lighting circuit is configured to control the N-by-M cluster within a matrix of the micro-LEDs associated with a vehicle headlamp.

3. The lighting circuit of claim 1, wherein each of the N×M power stages are arranged on circuit areas that have a pitch less than 100 micrometers.

4. The lighting circuit of claim 1, wherein each of the N×M power stages comprises a source follower power stage.

5. The lighting circuit of claim 1, wherein
N=2; and
M=2.

6. The lighting circuit of claim 1, wherein the equalizer subcircuit comprises a plurality of switches that are arranged and controlled to output the regulated voltage to each of the N×M power stages to regulate a source and a gate of each of the N×M power stages.

7. The lighting circuit of claim 6, wherein the N×M power stages comprise power transistors that are controlled via pulse modulation signals to deliver current to the N×M mirco-LEDs, wherein different pulse modulation signals for different ones of the power transistors are defined by controlling the plurality of switches of the equalizer subcircuit.

8. The lighting circuit of claim 7, wherein controlling the plurality of switches of the equalizer subcircuit is based on logic signals that define a number of pulse width modulation (PWM) quanta, wherein the PWM quanta define ON-OFF states for each of the N×M mirco-LEDs within a PWM duty cycle.

9. The lighting circuit of claim 8, wherein output of each of the N×M power stages is connected to the equalizer subcircuit, wherein the plurality of switches of the equalizer subcircuit further includes feedback switches, wherein the equalizer subcircuit is configured to deliver a feedback signal to the amplifier, wherein the feedback signal is defined by controlling the feedback switches based on the logic signal.

10. The lighting circuit of claim 1, wherein output of each of the N×M power stages is connected to the equalizer subcircuit, wherein the equalizer subcircuit is configured to deliver a feedback signal to the amplifier.

11. A method of controlling an N-by-M cluster of micro-light emitting diodes (micro-LEDs), wherein N and M are positive integers, the method comprising:
receiving, by an amplifier circuit, a reference voltage;
outputting, by the amplifier circuit, a regulated voltage to an equalizer subcircuit;
outputting, by the equalizer subcircuit, the regulated voltage to each of N×M power stages; and
driving, by the N×M power stages, N×M mirco-LEDs based on the regulated voltage.

12. The method of claim 11, wherein each of the N+M power stages comprises a source follower power stage.

13. The method of claim 11, wherein
N=2; and
M=2.

14. The method of claim 11, wherein the equalizer subcircuit comprises a plurality of switches, the method further comprising controlling the plurality of switches to output the regulated voltage to each of the N×M power stages.

15. The method of claim 14, wherein the N×M power stages comprise power transistors that are controlled via pulse modulation signals to deliver current to the N×M mirco-LEDs, the method further comprising controlling the plurality of switches of the equalizer subcircuit based on the pulse modulation signals.

16. The method of claim 15, wherein controlling the plurality of switches of the equalizer subcircuit is based on logic signals that define a number of pulse width modulation (PWM) quanta, wherein the PWM quanta define ON-OFF states for each of the N×M mirco-LEDs within a PWM duty cycle.

17. The method of claim 16, further comprising:
delivering output of each of the N+M power stages back to the equalizer subcircuit, wherein the plurality of switches of the equalizer subcircuit further includes feedback switches; and
delivering a feedback signal from the equalizer subcircuit to the amplifier, wherein the feedback signal is defined by controlling the feedback switches based on the logic signal.

18. The method of claim 11, wherein output of each of the N×M power stages is connected to the equalizer subcircuit, wherein the equalizer subcircuit is configured to deliver a feedback signal to the amplifier.

19. A lighting system comprising:
a matrix of micro-light emitting diodes (micro-LEDs), wherein the matrix includes greater than 2000 micro-LEDs;
a plurality of lighting circuits each configured to control a unique N-by-M cluster of the micro-LEDs, wherein N and M are positive integers,
wherein each of the plurality of lighting circuits comprises:
an amplifier circuit configured to receive a reference voltage and output a regulated voltage;
an equalizer subcircuit; and
N×M power stages configured to drive N×M mirco-LEDs, wherein equalizer subcircuit is configured to output the regulated voltage to each of the N×M power stages.

20. The lighting system of claim 19, wherein the lighting system comprises a vehicle headlamp.
